(19) United States
(12) Patent Application Publication
(10) Pub. No.: US 2012/0155485 A1
(43) Pub. Date: Jun. 21, 2012

(54) EFFICIENT SPACE UTILIZATION OF DISTRIBUTED MAC ADDRESS TABLES IN ETHERNET SWITCHES

(75) Inventors: Arun Saha, Sunnyvale, CA (US); Bijendra Singh, Plano, TX (US)

(73) Assignee: FUJITSU NETWORK COMMUNICATIONS, INC., Richardson, TX (US)

(21) Appl. No.: 12/970,449

(22) Filed: Dec. 16, 2010

(51) Int. Cl. H04L 12/56

(52) U.S. Cl. 370/419

(57) ABSTRACT

A method for networked communications includes receiving, on an inbound port, a frame to be forwarded, mapping the received frame to a flooding domain, determining an inbound port through which a frame is received, wherein the plurality of ports includes the inbound port, determining a destination address of the received frame, and determining one or more of the plurality of ports through which the received frame is to be forwarded. If the line card contains a port that is part of the flooding domain, the method includes populating a forwarding table associated with the line card with information regarding the received frame and information regarding the flooding domain. If the line card contains no ports that are part of the flooding domain, the method includes populating no forwarding tables associated with the line card with information regarding the received frame and information regarding the flooding domain.

### TECHNICAL FIELD OF THE INVENTION

The present invention relates generally to networked communications and, more particularly, to efficient space utilization of distributed MAC address tables in switches, including Ethernet switches.

### BACKGROUND

In distributed switching systems, switching entities perform information forwarding, learning, and aging out of forwarding entries. If a switching entity contains multiple switching subunits, each switching subunit may have its own forwarding table in which information about network addresses is stored. Switching functionalities such as information forwarding, learning, and aging out of forwarding entries are carried out on a per-switching subunit basis. This architecture requires that most of the configurations to operate a switch need to be applied on a per-switching subunit basis and must be repeated for each switching subunit.

### SUMMARY

In one embodiment, a switch includes a processor, a line card, one or more forwarding tables residing on the switch, and a plurality of ports. The processor is configured to determine an inbound port through which a frame is received, wherein the plurality of ports includes the inbound port, map the received frame to a flooding domain, determine a destination address of the received frame, and determine one or more of the plurality of ports through which the received frame is to be forwarded. If the line card contains a port that is part of the flooding domain, the processor is configured to populate one of the forwarding tables associated with the line card with information regarding the received frame and information regarding the flooding domain. If the line card contains no ports that are part of the flooding domain, the processor is configured to populate none of the forwarding tables associated with the line card with information regarding the received frame and information regarding the flooding domain.

In another embodiment, a method for networked communications includes receiving, on an inbound port, a frame to be forwarded, mapping the received frame to a flooding domain, determining an inbound port through which a frame is received, wherein the plurality of ports includes the inbound port, determining a destination address of the received frame, and determining one or more of the plurality of ports through which the received frame is to be forwarded. If the line card contains a port that is part of the flooding domain, the method includes populating a forwarding table associated with the line card with information regarding the received frame and information regarding the flooding domain. If the line card contains no ports that are part of the flooding domain, the method includes populating no forwarding tables associated with the line card with information regarding the received frame and information regarding the flooding domain.

In yet another embodiment, an article of manufacture includes a computer readable medium and computer-executable instructions carried on the computer readable medium. The instructions are readable by a processor. The instructions, when read and executed, cause the processor to receive, on an inbound port, a frame to be forwarded, map the received frame to a flooding domain, determine an inbound port through which a frame is received, determine a destination address of the received frame, and determine one or more of the plurality of ports through which the received frame is to be forwarded. If the line card contains a port that is part of the flooding domain, the processor is caused to populate a forwarding table associated with the line card with information regarding the received frame and information regarding the flooding domain. If the line card contains no ports that are part of the flooding domain, the processor is caused to populate no forwarding tables associated with the line card with information regarding the received frame and information regarding the flooding domain. The plurality of ports includes the inbound port.

### BRIEF DESCRIPTION OF THE DRAWINGS

For a more complete understanding of the present invention and its features and advantages, reference is now made to the following description, taken in conjunction with the accompanying drawings, in which:

FIG. 1 is an example of a switching system based upon a switch configured to forward information between networks, computing entities, or other switching entities;

FIG. 2 is an illustration of an example assignment of one or more ports to a flooding domain;

FIG. 3 is a more detailed illustration of the operation of a system and tables configured to provide efficient space utilization of distributed address tables in switches while flooding information;

FIG. 4 is a more detailed illustration of the operation of a system and tables configured to provide efficient space utilization of distributed address tables in switches while forwarding information;

FIG. 5 is an example embodiment of a method for efficient space utilization of distributed MAC address tables in switches; and

FIG. 6 is another example embodiment of a method for efficient space utilization of distributed MAC address tables in switches.

### DETAILED DESCRIPTION

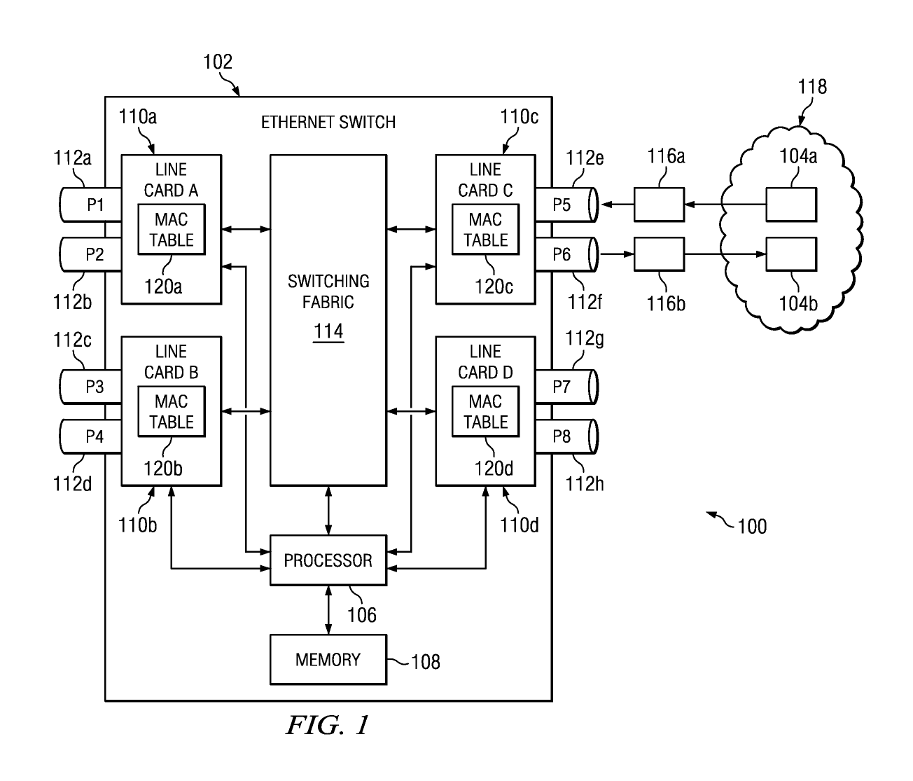

FIG. 1 is an example of a switching system 100 based upon a switch 102 configured to forward information between networks, computing entities, or other switching entities. In one embodiment, switching system 100 may be configured to provide efficient space utilization of distributed MAC address tables. Switch 102 may include one or more ports 112, each communicatively coupled to one or more network entities 104. Such coupling may be accomplished over a network 118. Switch 102 may include one or more line cards 110, coupled to each other by way of a switching fabric 114. Switch 102 may include a table 120 specific to each line card 110. Tables 120 may include communication and forwarding information regarding network entities connected to ports 112 for which addresses have been learned. Switch 102 may include a processor 106 coupled to a memory 108. Processor 106 may be coupled to switching fabric 114 and the line cards 110.

Inbound frame 116a may be implemented in packets, frames, cells, or other received data to be forwarded. When an inbound frame 116a is received into a given port 112, the destination of the information will be looked up in table 120 to determine which port 112 the information should be sent. As demonstrated in FIG. 1 and in subsequent figures, inbound frame 116a may be received on any suitable port 112 of switch 102.

Switch 102 may be implemented in any suitable electronic device for carrying out the embodiments taught by the present disclosure. In one embodiment, switch 102 may be implemented as an Ethernet switch. Switch 102 may be configured to receive information to be forwarded to network destinations, and the information may be implemented in any form suitable for switch 102 to forward. In one embodiment, the information received may be implemented in an inbound frame 116a. Likewise, switch 102 may be configured to forward information in any suitable form, and likely the same form in which it was received. In one embodiment, the forwarded information may be implemented in an outbound frame 116b.

Switch 102 may be configured to communicate with any suitable network entity 104 to receive and send information such as frames 116. Network entities 104 may be embodied by, for example, a computer, router, switch, network device, sub-network or network. Network 118 may be embodied by, for example, a local-area-network, wide-area-network, the Internet, an intranet, or any other suitable communications network. Switch 102 may be configured to send and receive information through ports 112 on their respective line cards 110. Switch 102 may be configured to determine upon receipt of a frame 116a, which of the ports 112 should the outbound frame 116b be sent, based in part upon the contents of tables 120 associated with each line card. Switch 102 may be configured to act upon received information by the configuration of line cards 110, switching fabric 114, and/or processor 106.

Line cards 110 may be implemented in any suitable manner to create the embodiments described in this disclosure. In one embodiment, line cards 110 may be implemented in a module including electronic circuitry, processors, and/or memory for handling communications through one or more ports 112. Each line card 110 may contain a table 120. In one embodiment, each table 120 may be implemented in the corresponding line card 110, such as being stored in a memory associated with the line card 110. In another embodiment, table 120 may be implemented elsewhere in switch 102. Line card 110 may be configured to determine to what other line cards 110 in switch 102, information received from port 112 should be forwarded. Line card 110 may be configured to make such determinations based on the contents of an associated table 120. Line card 110 may be configured to forward information received from port 112 to another line card 110 of switch 102 through switching fabric 114. Switching fabric 114 may be implemented in any suitable combination of hardware and software for connecting line cards 110 to each other to transmit information between the line cards 110. Switching fabric 114 may be controlled through configuration by processor 106.

Processor 106 may comprise, for example, a microprocessor, microcontroller, digital signal processor (DSP), application specific integrated circuit (ASIC), or any other digital or analog circuitry configured to interpret and/or execute program instructions and/or process data. Processor 106 may interpret and/or execute program instructions and/or process data stored in memory 108. Memory 108 may comprise any system, device, or apparatus configured to hold and/or house one or more memory modules. Each memory module may include any system, device or apparatus configured to retain program instructions and/or data for a period of time (e.g., computer-readable media). In one embodiment, each line card 110 may contain one or more memory modules, containing at least an associated table 120. In another embodiment, each line card 110 may share memory 108 to store tables 120.

Tables 120 may be implemented in any suitable manner to store and make available to switch 102 and line cards 110 information concerning other network entities 104 in switching system 100 and how the network entities 104 may be accessed through ports 112. Tables 120 may include, for example, information regarding addresses of network entities 104, information regarding flooding domains 202, and information regarding which port 112, the address may be reached. Tables 120 may be configured as forwarding tables to provide information to switch 102 on how to forward information to other entities. In one embodiment, each table 120 may be implemented in its respective line card 110. In another embodiment, tables 120 may be implemented together, but coupled to each line card 110. Tables 120 may be implemented, for example, in logic, a memory, or circuitry. If a table 120 is implemented in a line card 110, table 120 may be implemented in memory of line card 110.

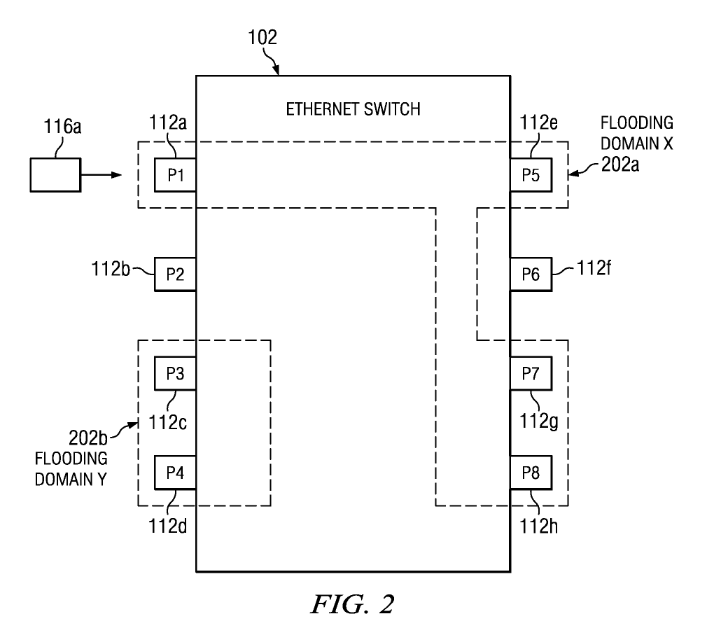

FIG. 2 is an illustration of an example assignment of one or more ports 112 to a flooding domains. In the example of FIG. 2, ports P1, P5, P7, and P8 are assigned to flooding domain 202a, while ports P3 and P4 are assigned to flooding domain 202b. Association of ports with flooding domains may be accomplished by processor 106, switching fabric 114, or any other suitable portion of switch 102. Flooding domains 202 may be associated with a VLAN. A flooding domain 202 may represent all ports 112 of switch 102 that will be flooded if the actual location of the destination of inbound frame 116a is not known. Such ports will be flooded by forwarding inbound frame 116a to each network destination 104 coupled to each such port 112. In the example of FIG. 2, an inbound frame 116a may be received on port P1. For example, if inbound frame 116a contains a destination MAC address of “0000.0000.1111,” and no such entry exists in the tables associated with the flooding domain, then the frame may be forwarded through ports P5, P7, and P8. If such an address was known in the tables associated with the flooding domain, then the entry for the address would identify the appropriate egress port through which the frame would be sent. The ports 112 of switch 102 may be arranged into flooding domains 202 in any suitable fashion. In one embodiment, the ports 112 of switch 102 may be rearranged during operation of the switch 102. A port 112 of switch 102 may be associated with more than one flooding domain 202. In such a case, such a port 112 may forward information assigned to more than one flooding domain to the network destination 104 coupled to such port 112.

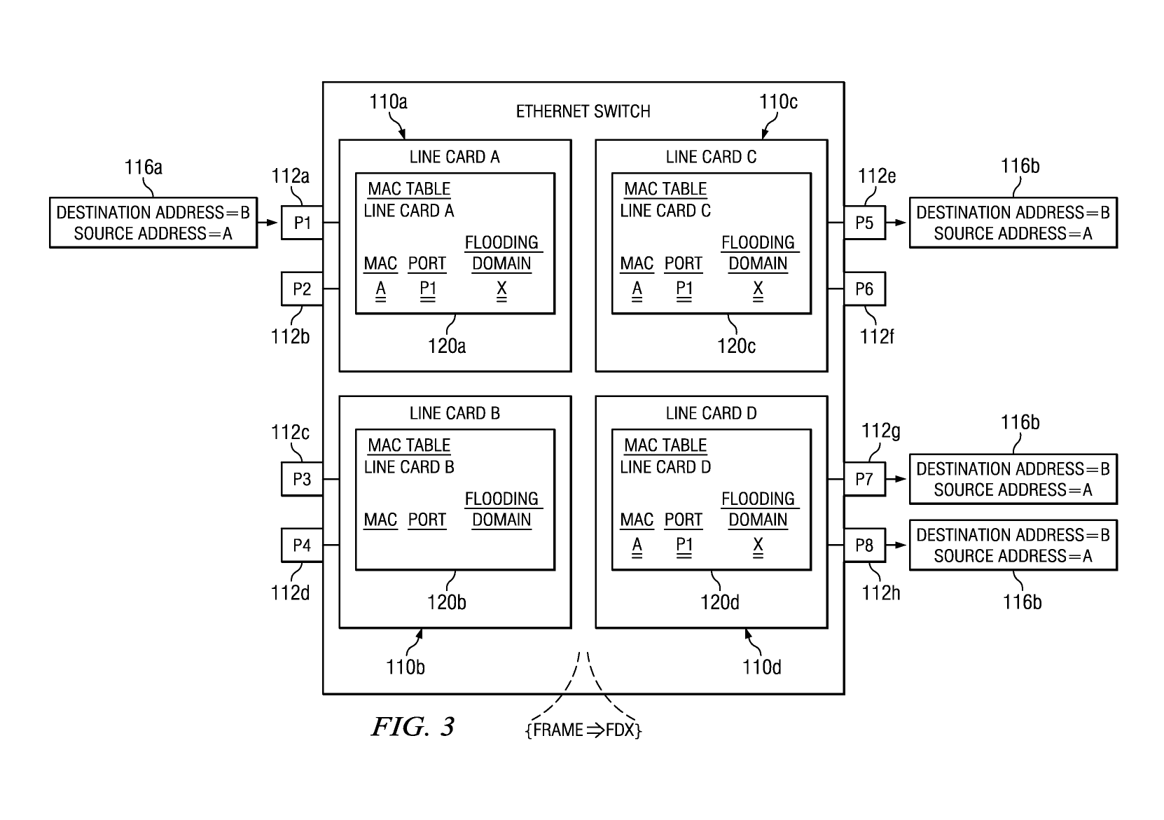

FIG. 3 is a more detailed illustration of the operation of system 100 and tables 120 configured to provide efficient space utilization of distributed address tables in switches while flooding information. Table 120 may include information, for a given address and flooding domain, identifying which port 112 may be used to access the address. The addresses used by table 120 may comprise MAC addresses.

An inbound frame 116a to be forwarded to a network destination 104 may be received by switch 102 and may contain a source address and a destination address of the frame. In the example of FIG. 3, the inbound frame 116a may be received on port P1 and may contain a destination address of “B” and a source address of “A.” The inbound frame 116a may be received on any suitable port 112, and may contain any suitable destination and source address. Similarly, an outbound frame 116b forwarded by switch 102 may contain a source address and a destination address of the frame. The outbound frame 116a may be sent through any suitable port 112. In various embodiments, schemes for intermediate addresses or metatags may be used to increase the scalability and usability of addresses.

Upon the arrival of inbound information, such as frame 116a, switch 102 may be configured to determine the destination address and source address of the frame. Such a determination may be made by, for example, by examination of header information within frame 116a. Switch 102 may be configured to map the frame to any flooding domains, such as the flooding domains 202 of FIG. 2. Such a mapping may be made by, for example, rules based upon the port 112, the nature of the information within the frame, or other suitable information.

Switch 102 may be configured to determine whether the destination address is known within the table 120 of ingress line card 110 of switch 102. If the destination address is not known within the table 120 of ingress line card 110, the switch 102 may be configured to flood all remaining ports 112 in the flooding domain 202 with a copy of the frame 116a. In one embodiment, switch 102 may be configured to only flood those ports 112 associated with the flooding domain to which the frame was mapped. This selective flooding may need less resources than simply flooding all ports 112 of switch 102.

If the source address of the inbound frame 116 is not known in the table 120 of the ingress line card 110, then switch 102 may be configured to populate tables 120 with newly discovered information, such as the association of the source address of the inbound frame 116a with the ingress port 112, and the flooding domains 202 the frame is associated with. However, simply copying such information into each table 120 may generate many entries that are not necessary. Switch 102 may be configured to populate only those tables 120 which need to know the newly learned address.

In one embodiment, switch 102 may only populate tables 120 which are associated with a line cards 110 on which a flooding domain associated with the inbound frame 116 is active. A flooding domain may be active on a line card 110, or other line cards of switch 102, if that flooding domain contains a port 112 on any such line card on switch 102. Consequently, switch 102 may be configured to determine, for the flooding domain mapped to the inbound frame, what ports 112 are included in the flooding domain from line cards 110 in which the flooding domain is active. Switch 102 may be configured to only populate those tables 120 that are associated with a line card on which the flooding domain is active, wherein the flooding domain is mapped to the inbound frame 116a. Switch 102 may be configured to forward an outbound frame 116b to each port 112 that is included in the flooding domain from line cards 110 in which the flooding domain is active.

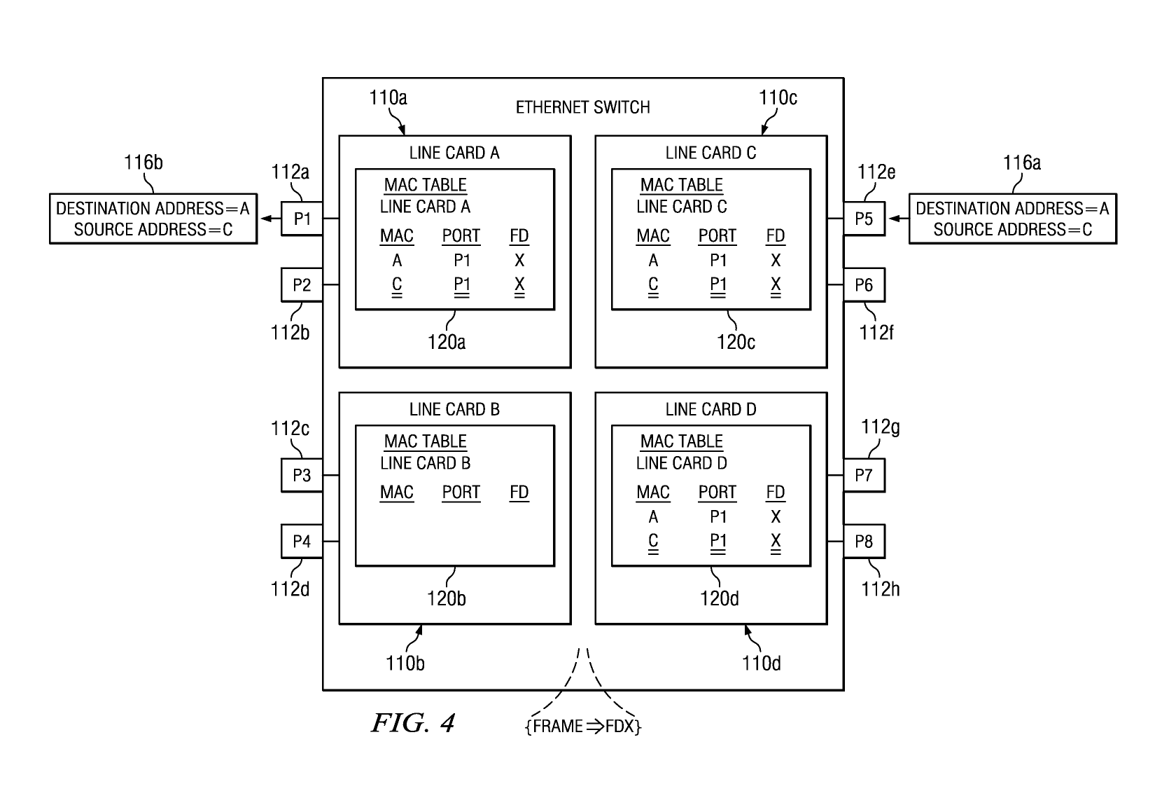

FIG. 4 is a more detailed illustration of the operation of system 100 and tables 120 configured to provide efficient space utilization of distributed address tables in switches while forwarding information. In the example of FIG. 4, an inbound frame 116a may be received on port P5, and contain a destination address of “A” and a source address of “C.” The inbound frame 116a may be received on any suitable port 112 of switch 102, and contain any suitable destination address or source address. Switch 102 may be configured to determine whether the destination address of an inbound frame 116a is known within the tables 120 of switch 102. If the destination address is known within the tables 120 of switch 102, switch 102 may be configured to forward the frame to the port 112 identified by table 120.

If the source address of the inbound frame 116a was not known in the tables 120 of switch 102, then switch 102 may be configured to populate tables 120 with newly discovered information, such as the association of the source address of the inbound frame 116 with the port 112 through which it was received. However, as in FIG. 3, switch 102 may be configured to populate only those tables 120 which need to learn this newly learned address. Switch 102 may be configured to map the inbound frame 116a to a flooding domain. Switch 102 may be configured to then determine which tables 120 on line cards 110, the flooding domain is active. Switch 102 may be configured to only populate those tables 120 that are associated with line cards 110 on which the flooding domain, wherein the inbound frame is mapped to the flooding domain, is active. Switch 102 may be configured to forward an outbound frame 116b on a port 112 corresponding to information within tables 120.

In operation, switch 102 may be communicating with network destinations 104. Switch 102 may receive frames to be forwarded, for example, from one network source 104a to another network destination 104b. Switch may be receiving and forwarding frames over network 118.

Switch 102 may receive a frame 116a through a port 112 associated with a line card 110. Switch 102 may map the inbound frame 116a to a flooding domain 202. Line card 110 may consult table 120 to determine whether the destination address of the frame 116a is known. If the destination address of the frame is not known within tables 120, then each port 112 within the flooding domain may be flooded with a copy of the frame 116a. For example, in FIG. 3, incoming frame 116a received on P1 may be mapped to flooding domain X. if frame 116a contains a destination address of “B,” initially tables 120a, 120b, 120c, and 120d may not contain information associated with the address “B.” Consequently the frame is flooded to each of the other ports in flooding domain X, namely, P5, P7, and P8.

Switch 102 may determine whether the tables 120 are already populated with the information in the inbound frame 116a. If not, switch 102 may populate tables 120 with the information in the inbound frame 116a. Switch 102 may determine which tables 120 are associated with ports 112 that are active within the mapped flooding domain 202. In one embodiment, switch 102 may populate only those tables 120 that are associated with active ports 112 within the mapped flooding domain 202. For example, switch 102 may determine that the inbound frame 116a is mapped to flooding domain X, and contains a source address of “A,” and was received through P1. Switch 102 may determine the line cards on which the flood domain is active, and the flood domain contains ports P1, P5, P7 and P8. Consequently, tables 120a, 120c, and 120d are associated with ports that are active within the flooding domain of the inbound frame; however, table 120b is not. Switch 102 may thus determine whether information determined from the inbound frame is found within the tables 120a, 120c, and 120d. If the information is not found within such tables 120, then, as shown in FIG. 3, the such tables 120a, 120c, and 120d may be populated with information showing that MAC address “A” may be reached through the port P1, and is associated with flooding domain X. Table 120d may not be populated. Thus, table 120d may have more entries available for additional population. Such an increase in effective capacity may allow table 120d to go longer periods of time without timing out entries, which in turn may decrease the number of subsequent frames that may need to be flooded. Such larger effective capacity will also reduce the amount of flooding required, because where tables are full, the destination information might not be found and subsequent flooding required. Such an increase in effective capacity of table 120b may increase the capacity of switch 102.

Switch 102 may receive a frame 116a through a port 112 associated with a line card 110, for which the destination address of the frame 116a is known. If the destination address of the frame is known within tables 120, then a copy of the frame may be transmitted through the port 112 associated with the destination address. For example, in FIG. 4, an incoming frame 116a received on P5 may be mapped to flooding domain X. If frame 116a contains a destination address of “A,” table 120c associated with the line card 110 hosting port P5 may indicate that address “A” may be reached by way of P1. Consequently, the frame will be forwarded from P5 through switching fabric 114 to P1, and to the network destination 104 coupled to P1.

As described above, switch 102 may determine whether the tables 120 are populated with the information in the inbound frame 116a, and, if not, populate tables 120 for line cards 110 where the flooding domain 202 of the inbound frame 116a is active. For example, switch 102 may determine that the inbound frame 116a is mapped to flooding domain X, and contains a source address of “C,” and was received through P5. Switch 102 may determine that the ports P1, P5, P7, and P8 are active within flooding domain X. Consequently, tables 120a, 120c, and 120d are associated with ports that are active within the flooding domain of the inbound frame; however, table 120b is not. Switch 102 may thus determine whether information determined from the inbound frame is found within the tables 120a, 120c, and 120d. If the information is not found within such tables 120, then, as shown in FIG. 4, the such tables 120a, 120c, and 120d may be populated with information showing that MAC address “C” may be reached through the port P5, and is associated with flooding domain X. Table 120b may be left unchanged. Thus, table 120b may have more entries available for additional population.

In one embodiment, switch 102 determine the active ports 112 for a given flooding domain 202, and then examine tables 120 to determine whether the table 120 contains information for an address and port combination for an inactive flooding domain. If an entry is found within a table 120 which belongs to a flooding domain 202 which is not active on a line card 110 or port 112 associated with the table 120, then the entry may be removed. For example, if table 120b contained an entry associating address “A” with P1 for the flooding domain X, switch 102 may determine that flooding domain X is not active on P3 or P4, and thus remove the entry from table 120b.

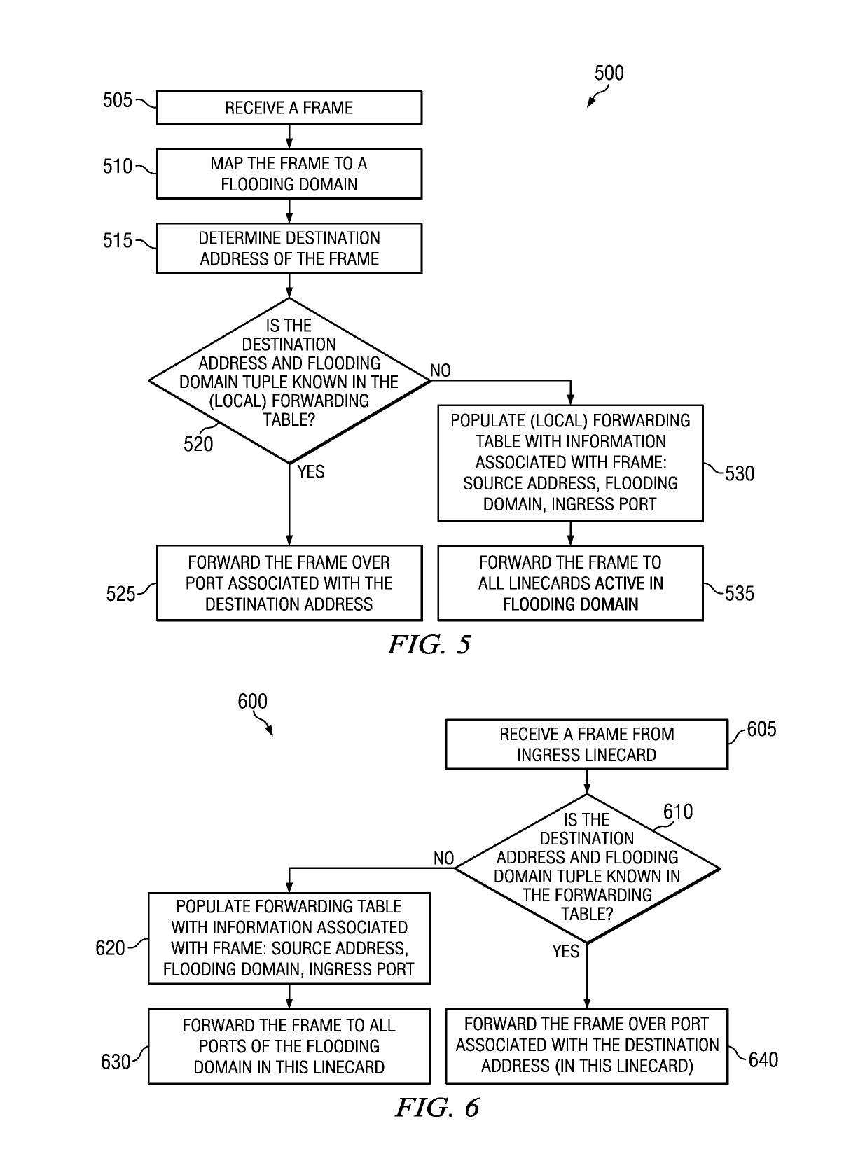

FIG. 5 is an example embodiment of a method 500 for efficient space utilization of distributed MAC address tables in switches. In step 505, information, such as a frame, to be forwarded over a network may be received. Such information may be received from, for example, a network destination coupled to a port of a network device. In step 510, a frame may be mapped to a flooding domain.

In step 515, the destination address of the frame may be determined. In step 520, a tuple of the destination address and the flooding domain may be looked up in a local forwarding table. Information associated with the flooding domain may include ports in which the flooding domain is active. If the destination address and flooding domain tuple is found within such tables, associating the address with a port through which the address may be reached, then in step 525, the frame may be forwarded over such a port associated with the destination address.

If the destination address and forwarding domain tuple is not found, then in step 530 the forwarding table may be populated with information associated with the frame. Such information may include the source address, the flooding domain, and the ingress port. In step 535, the frame may be flooded to all the line cards active in the flooding domain. Steps 505-535 may be repeated for each frame received at a switch, including frames received by an ingress line card.

FIG. 6 is another example embodiment of a method 600 for efficient space utilization of distributed MAC address tables in switches. Method 600 may be repeated for each egress line card in a flooding domain. Instances of method 600 may be initiated upon completion of step 535 of method 500.

In step 605, information, such as a frame, to be forwarded over a network may be received. Such a reception may be from an ingress line card. The frame may contain a destination address. The frame may also be mapped to a flooding domain. In step 610, it may be determined whether the tuple of the destination address of the frame and a flooding domain to which the frame is mapped are known in the local forwarding table. In one embodiment, the local forwarding table may be associated with the egress line card. If the tuple is known, then in step 640 the frame may be forwarded over a port associated with the destination address. The port may be determined from the forwarding table, as a result of looking up the tuple. The port may be associated with the destination address for the purposes of the local line card.

If the tuple is not known, then in step 620 the forwarding table may be populated with forwarding information associated with the frame. Such forwarding information may include a source address, flooding domain, or ingress port. In step 630, the frame may be forwarded to all ports of the associated flooding domain. In one embodiment, the ports through which the frame is forwarded may include the ports of the egress line card

Although FIG. 5 and FIG. 6 discloses a particular number of steps to be taken with respect to example methods 500 and 600, methods 500 and 600 may be executed with more or fewer steps than those depicted in FIG. 5 and FIG. 6. In addition, although FIG. 5 and FIG. 6 disclose a certain order of steps to be taken with respect to method 500, the steps comprising methods 500 and 600 may be completed in any suitable order.

Methods 500 and 600 may be implemented using the system of FIGS. 1-4, or any other system, network, or device operable to implement methods 500 and 600. In certain embodiments, methods 500 and 600 may be implemented partially or fully in software embodied in computer-readable media.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, and other tangible, non-transitory media; and/or any combination of the foregoing.

Although the present disclosure has been described in detail, it should be understood that various changes, substitutions, and alterations can be made hereto without departing from the spirit and the scope of the disclosure as defined by the appended claims.

What is claimed is:

1. A switch, comprising:
a processor;
a line card;
one or more forwarding tables residing on the switch; and
a plurality of ports,
wherein the processor is configured to:
determine an inbound port through which a frame is received, wherein the plurality of ports includes the inbound port;
map the received frame to a flooding domain;
determine a destination address of the received frame;
determine one or more of the plurality of ports through which the received frame is to be forwarded;
if the line card contains a port that is part of the flooding domain, populating one of the forwarding tables associated with the line card with information regarding the received frame and information regarding the flooding domain; and
if the line card contains no ports that are part of the flooding domain, populating none of the forwarding tables associated with the line card with information regarding the received frame and information regarding the flooding domain.

2. The switch of claim 1, wherein:
the processor is coupled to a memory; and
one or more of the forwarding tables residing on the switch are stored in the memory.

3. The switch of claim 1, wherein the line card comprises one or more ports.

4. The switch of claim 1, wherein:
the line card includes a memory; and
one or more of the forwarding tables residing on the switch is stored in the memory included in the line card.

5. The switch of claim 1, wherein each of the forwarding tables is associated with the line card.

6. The method of claim 1, wherein the processor is further configured to flood the received frame to ports active in the flooding domain.

7. The method of claim 1, wherein the information regarding the received frame includes a source address of the received frame.

8. A method for networked communications, comprising:
receiving, on an inbound port, a frame to be forwarded;
mapping the received frame to a flooding domain;
determining an inbound port through which a frame is received, wherein the plurality of ports includes the inbound port;
determining a destination address of the received frame;
determining one or more of the plurality of ports through which the received frame is to be forwarded;
if the line card contains a port that is part of the flooding domain, populating a forwarding table associated with the line card with information regarding the received frame and information regarding the flooding domain; and
if the line card contains no ports that are part of the flooding domain, populating no forwarding tables associated with the line card with information regarding the received frame and information regarding the flooding domain.

9. The method of claim 8, wherein the ports are hosted on a line card.

10. The method of claim 8, wherein the forwarding table is hosted on the line card.

11. The method of claim 8, further comprising flooding the received frame to ports active in the flooding domain.

12. An article of manufacture comprising:
a computer readable medium; and
computer-executable instructions carried on the computer readable medium, the instructions readable by a processor, the instructions, when read and executed, for causing the processor to:
receive, on an inbound port, a frame to be forwarded;
map the received frame to a flooding domain;
determine an inbound port through which a frame is received, wherein the plurality of ports includes the inbound port;
determine a destination address of the received frame;
determine one or more of the plurality of ports through which the received frame is to be forwarded;
if the line card contains a port that is part of the flooding domain, populate a forwarding table associated with the line card with information regarding the received frame and information regarding the flooding domain; and
if the line card contains no ports that are part of the flooding domain, populate no forwarding tables associated with the line card with information regarding the received frame and information regarding the flooding domain.

13. The article of claim 12, wherein the ports are hosted on a line card.

14. The article of claim 12, wherein the forwarding table is hosted on the line card.

15. The article of claim 12, wherein the processor is further configured to flood the received frame to ports active in the flooding domain.
